(19) United States
(12) Patent Application Publication
(10) Pub. No.: US 2026/0021730 A1
(43) Pub. Date: Jan. 22, 2026

(54) AUTOMATIC CHARGING SYSTEM

(71) Applicant: TOYOTA JIDOSHA KABUSHIKI KAISHA, Toyota-shi Aichi-ken (JP)

(72) Inventors: Hironaga ONO, Toyota-shi Aichi-ken (JP); Ritsu NISHIMURA, Nagoya-shi Aichi-ken (JP); Hiroaki NISHINO, Toyota-shi Aichi-ken (JP); Yohei ONO, Nisshin-shi Aichi-ken (JP); Ryohei CHINO, Nisshin-shi Aichi-ken (JP); Shimpei ISOBE, Toyota-shi Aichi-ken (JP); Manabu HIROSE, Okazaki-shi Aichi-ken (JP)

(73) Assignee: TOYOTA JIDOSHA KABUSHIKI KAISHA, Toyota-shi Aichi-ken (JP)

(21) Appl. No.: 19/268,173

(22) Filed: Jul. 14, 2025

(30) Foreign Application Priority Data
Jul. 19, 2024 (JP) 2024-116137

(51) Int. Cl. B60L 53/37; B60L 53/16; B60L 53/60; H01R 43/26

(52) U.S. Cl. CPC B60L 53/37; B60L 53/16; B60L 53/60; H01R 43/26

(57) ABSTRACT

An automatic charging system includes: a charger to which a charging cable having a charging connector is connected; an automatic charging robot, including a robot arm having a robot hand, for inserting the charging connector into a charging port of a vehicle for charging; a detector for detecting a distance between the automatic charging robot and a person; and a controller for controlling an operation of the automatic charging robot for automatic charging to the vehicle. Further, the controller executes a cooperative mode, in which the robot arm is operated in a manner that an output of the robot arm is limited to a predetermined value and a predetermined execution condition is satisfied, and operates the robot arm while turning off the cooperative mode when confirmed that there is no person or animal detected near the automatic charging robot in response to a signal from the detector.

### CROSS-REFERENCE TO RELATED APPLICATION(S)

The present application claims priority to and incorporates by reference the entire contents of Japanese Patent Application No. 2024-116137 filed in Japan on Jul. 19, 2024.

### BACKGROUND

The present disclosure relates to an automatic charging system.

Japanese Laid-open Patent Publication No. 2024-029652 discloses an automatic charging system including a charger to which a charging cable including a charging connector is connected, and an automatic charging robot for automatically grasping and inserting the charging connector to a charging port of a vehicle.

### SUMMARY

There is a need for providing an automatic charging system capable of controlling an automatic charging robot in a cooperative mode and suppressing insufficient insertion and extraction load of the charging connector.

According to an embodiment, an automatic charging system includes: a charger, installed in a charging facility, to which a charging cable having a charging connector is connected; an automatic charging robot, including a robot arm having a robot hand at a tip portion thereof, for inserting the charging connector, which is gripped by the robot hand, into a charging port of a vehicle for perform charging; a detector, provided in an infrastructure facility in a vicinity of the charging facility, for detecting a distance between the automatic charging robot and a person; and a controller for controlling an operation of the automatic charging robot when performing automatic charging to the vehicle. Further, the controller executes a cooperative mode, in which the robot arm is operated in a manner that an output of the robot arm is limited to a predetermined value when controlling an operation of the robot arm to charge the vehicle and a predetermined execution condition is satisfied, and operates the robot arm while turning off the cooperative mode when it is confirmed that there is no person or animal detected near the automatic charging robot in response to a signal input from the detector during execution of the cooperative mode.

### BRIEF DESCRIPTION OF THE DRAWINGS

FIG. 1 is a diagram illustrating an overall configuration of an automatic charging system according to an embodiment; and

FIG. 2 is a flowchart illustrating a control flow of an automatic charging robot.

### DETAILED DESCRIPTION

Generally, industrial robots are installed in a place surrounded by fences. When installing an automatic charging robot having an industrial robot in such a place where there is no fence in the surroundings, it is necessary to execute a cooperative mode which restricts the output of the robot arm in order to allow a person to be near the automatic charging robot. However, there is a possibility that a load for plugging and unplugging of the charging connector is insufficient in the output of the robot arm in a state of being controlled to the cooperative mode.

It will be specifically described below automatic charging system in the embodiment of the present disclosure. Note that the present disclosure is not limited to the embodiments described below.

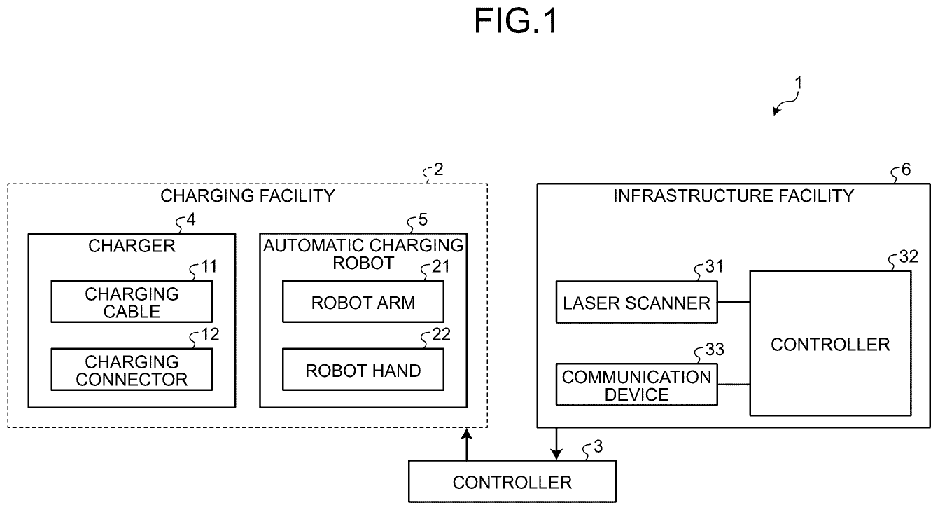

FIG. 1 is a diagram illustrating an overall configuration of an automatic charging system according to an embodiment. The automatic charging system 1 includes a charging facility 2 and a controller 3. The automatic charging system 1 is a system for automatically charging a vehicle by a charger 4 and an automatic charging robot 5 provided in the charging facility 2 when the vehicle is charged using the charging facility 2. The vehicle is an electric vehicle capable of external charging. The automatic charging system 1 is configured to automatically insert and remove a charging connector 12 of the charger 4 to a charging port of the vehicle.

The charging facility 2 includes the charger 4, the automatic charging robot 5.

The charger 4 has a charging cable 11 and a charging connector 12. The charging cable 11 is a cable connected to the charger 4. The charging connector 12 is connected to the charging cable 11. The charger 4 and the charging connector 12 are connected via the charging cable 11.

The automatic charging robot 5 has a robot arm 21 and a robot hand 22. The automatic charging robot 5 is installed near the charger 4 to perform charging by automatically inserting the charging connector 12 to the charging port of the vehicle. The automatic charging robot 5 is constituted by a vertically articulated robot of a six-axis mechanism, for example. The automatic charging robot 5 is installed in a place where there is no fence in the circumference.

The robotic arm 21 automatically plugs and unplugs the charging connector 12 to and from the charging port of the vehicle. The robot hand 22 is provided at a tip of the robot arm 21. The robotic hand 22 grasps the charging connector 12. The robotic arm 21 actuates to displace the position of the robotic hand 22 to a desired position.

The controller 3 is a control device of the automatic charging system 1. The controller 3 controls the automatic charging robot 5. When the vehicle performs automatic charging using the charging facility 2, the controller 3 controls the operation of the robot arm 21 of the automatic charging robot 5.

For example, the controller 3 controls the automatic charging robot 5 in a cooperative mode. The cooperative mode is a mode in which the robot arm 21 moves only at a certain output or less. That is, the cooperative mode is a mode in which the output of the robot arm 21 is limited to a predetermined value to operate the robot arm 21. When the controller 3 executes the cooperative mode, the output of the robot arm 21 becomes weaker than usual in the automatic charging robot 5. The controller 3 operates the robot arm 21 by limiting the output of the robot arm 21 to a predetermined value in a cooperative mode. The predetermined value is a value set in advance. The output of the robot arm 21 is defined by the transportable weight and the operating speed. In the cooperative mode, at least one of the transportable weight and the operation speed of the robot arm 21 is limited. The predetermined value of the cooperative mode can be set for each of the limit value of the transportable weight and the limit value of the operation speed.

In the automatic charging system 1 configured as described above, since the robot arm 21 is controlled to the cooperative mode, even when a person or an animal approaches the automatic charging robot 5 with interest, the load on which the robot arm 21 or the robot hand 22 contacts the person or the animal can be reduced. However, the insertion and removal load of the charging connector 12 may be insufficient at the output of the robot arm 21 which is controlled to the cooperative mode. For example, when inserting the charging connector 12 to the charging port of the vehicle, the automatic charging robot 5 may obliquely insert the charging connector 12 to the charging port of the vehicle. In such a case, for example, if the charging connector 12 is twisted, a case is assumed that the output a large load from the robot arm 21 is desired. This may be the same when pulling out the charging connector 12 from the charging port of the vehicle. Therefore, the controller 3 controls the output of the robot arm 21 of the automatic charging robot 5 based on the information acquired by the laser scanner 31 of an infrastructure facility 6. The controller 3 signals are input from the infrastructure facility 6. Since a detection device such as a laser scanner 31 is installed in the infrastructure facility 6, the controller 3 detects that there is a person or animal near the automatic charging robot 5 by using the laser scanner 31 installed in the infrastructure facility 6 near the charging facility 2 without installing a dedicated detection sensor.

The infrastructure facility 6 includes a laser scanner 31, a controller 32, and a communication device 33.

The laser scanner 31 irradiates a laser beam in a pulse shape, measures the time difference until it bounces against the object, and measures the distance, position, and shape in three dimensions. The laser scanner 31 is constituted by, for example, a Light Detection And Ranging (LIDAR). The laser scanner 31 is an infrastructure-side device provided in the charging facility 2, and is a detection device for detecting a vehicle using the charging facility 2. The laser scanner 31 is provided in the infrastructure facility 6 near the charging facility 2 to detect the distance between the automatic charging robot 5 and a person. Information about the distance sensed by the laser scanner 31 is output to the controller 32.

The controller 32 is an infrastructure-side controller. The controller 32 controls laser scanner 31 and communication device 33. The controller 32 provides distance information acquired by the laser scanner 31 from the communication device 33 to the controller 3.

The communication device 33 communicates with the controller 3. The communication device 33 transmits information acquired by the infrastructure facility 6 side to the controller 3.

The automatic charging system 1 is configured to control the operation of the automatic charging robot 5 based on the distance information obtained from the laser scanner 31 installed in the infrastructure facility 6 in the vicinity of the charging facility 2. That is, the controller 3 can change at least one of the transportable load and the operation speed of the robot arm 21 according to the distance between the automatic charging robot 5 and the person.

Specifically, the controller 3 determines whether there is a person or an animal near the automatic charging robot 5 in accordance with the distance information by the laser scanner 41 acquired from the infrastructure facility 6. If it is determined that there are no people or animals in the vicinity of the automatic charging robot 5 during automatic charging, the controller 3 may turn off the cooperative mode to activate the robot arm 21. If the cooperative mode is turned off, the controller 3 may activate the robot arm 21 with a greater output than the cooperative mode. The controller 3, by turning off the cooperative mode, relaxes the output limit of the robot arm 21, and it is possible to increase the insertion and removal load of the charging connector 12 as necessary.

For example, when the controller 3 turns off the cooperative mode, the mode of the automatic charging robot 5 is switched from the cooperative mode to the standard operation mode. The standard operation mode is a mode that maximizes the capability of the automatic charging robot 5. The controller 3, when controlling the operation of the robot arm 21 to charge the vehicle, can switch between the cooperative mode and the standard operation mode. The predetermined value of the cooperative mode is a value smaller than the output of the standard operation mode. In the cooperative mode, the output of the robot arm 21 is limited to a value smaller than that in the standard operation mode. If the output of the robot arm 21 becomes smaller than that in the standard operation mode in the cooperative mode, the transportable load and the operation speed of the robot arm 21 become smaller than that in the standard operation mode.

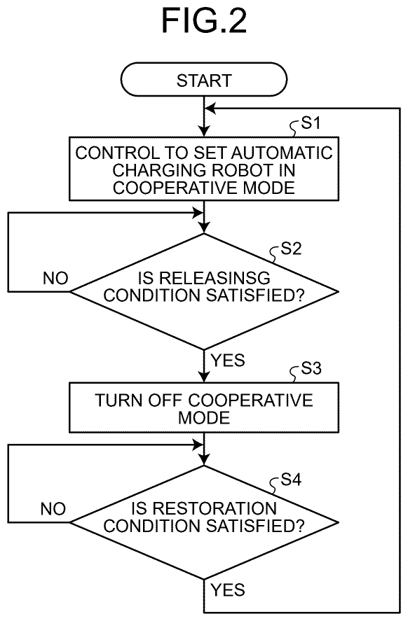

FIG. 2 is a flowchart illustrating a control flow of the automatic charging robot. The control illustrated in FIG. 2 is performed repeatedly by the controller 3 during automatic charging.

The controller 3 controls the automatic charging robots 5 in cooperative mode during automatic charging (step S1). In step S1, the auto-charging robot 5 is operated in the cooperative mode when the predetermined execution condition is satisfied. As an execution condition for executing the cooperative mode, a charging start condition is exemplified. If the execution condition is a charging start condition, the operation of the robot arm 21 in the cooperative mode is started by satisfying the charging start condition. The charging start condition includes that the safety of the surrounding is confirmed by the laser scanner 31 in a state where the vehicle is stopped at a predetermined stop position.

The controller 3 determines whether a release condition for releasing the cooperative mode is satisfied (step S2). In step 32, it is determined whether the release condition is satisfied based on the distance between the auto-charging robot 5 and the person measured by the laser scanner 31. The release condition is a condition for turning off the cooperative mode. The release condition includes that it has been confirmed by the laser scanner 31 that there is no person or animal around the automatic charging robot 5. For example, if there is no person or animal within 10 meters of the automatic charging robot 5, the release condition is satisfied. In step S2, the controller 3 determines whether there are no persons or animals within a 10-meter range around the auto-charging robotic 5 during auto-charging.

If the release condition is determined not to be satisfied (step S2: No), the control routine performs the process of step S2 again.

If the release condition is determined to be satisfied (step S2: Yes), the controller 3 turns off the cooperative mode (step S3). In step S3, the controller 3 turns off the cooperative mode so that the robotic arm 21 is powered up more than in the cooperative mode. The controller 3 turns off the cooperative mode to make at least one of the transportable load and the motion speed of the robot arm 21 larger than that in the cooperative mode. For example, the controller 3 controls the operation of the robot arm 21 so that the operation speed of the robot arm 21 does not change with on and off of the cooperative mode, but changes the portable load of the robot arm 21 with on and off of the cooperative mode. In this instance, in step S3, the controller 3 changes the transportable load of the robotic arm 21 to a larger value than in the cooperative mode.

The controller 3 determines whether a restoration condition is satisfied while the cooperative mode is turned off (step S4). The restoration condition is the condition to return from the state in which the cooperative mode is turned off to the state in which the cooperative mode is turned on. The restoration condition includes that the presence of a person or an animal around the automatic charging robot 5 has been confirmed by the laser scanner 31. When there is a person or an animal within a 5-meter radius of the automatic charging robot 5, for example, during execution of the cooperative mode, the restoration condition is established. In step S4, it is determined whether there is a person/animal in the vicinity of the automatic charging robot 5 during automatic charging. In step S4, the controller 3 determines if there are people/animals within a 5-meter radius of the auto-charging robots 5.

If the restoration condition is determined not to be satisfied (step S4: No), the control routine performs the process of step S4 again.

If the restoration condition is determined to be satisfied (step S4: Yes), the control routine is returned to step S1, the controller 3 resumes the cooperative mode.

As described above, according to the embodiment, it is possible to turn off the cooperative mode when there is no person or animal near the automatic charging robot 5 during automatic charging, and the insertion and removal load of the charging connector 12 can be increased as necessary.

The detection device in the automatic charging system 1 is not limited to the laser scanner 31, and may be an infrastructure camera. The infrastructure camera is a camera installed in the infrastructure facility 6 and includes a plurality of cameras provided in the parking lot where the charger 4 and the automatic charging robot 5 are installed. In this case, the controller 3 controls the operation of the automatic charging robot 5 by calculating the distance between the automatic charging robot 5 and the person based on the image captured by the infrastructure camera.

Further, the range indicated by the return condition is not limited within a range of 5 meters radius centered on the automatic charging robot 5. This radius is not limited to 5 meters, but may be from several meters to about 10 meters. Furthermore, this range may not be the range centered on the automatic charging robot 5. For example, it may range of several meters from the operating range of the robot arm 21.

Further, the output change control may be performed so as to change the output of the robot arm 21 according to the relative distance between the automatic charging robot 5 and the person. The output change control is a control to gradually increase the output of the robot arm 21 as the relative distance between the automatic charging robot 5 and the person increases. By the controller 3 that implements the output change control, the mode of the automatic charging robot 5 is the output change mode. In this case, the controller 3 is capable of executing the cooperative mode and the output change mode and the standard operation mode. When the controller 3 turns off the cooperative mode, it performs either the output change mode and the standard operation mode. The controller 3 may turn off the cooperative mode and turn on the output change mode. The controller 3 can switch the mode of the automatic charging robot 5 from the cooperative mode to the output change mode. When the cooperative mode is turned off, although the standard operation mode is included, it does not necessarily mean to become the standard operation mode.

In addition, the execution condition of the cooperative mode is not limited to the charging start condition. The predetermined execution condition may be a switching condition for switching from the standard operation mode to the cooperative mode. In short, the standard operation mode may be executed before executing the cooperative mode. When the execution condition is a switching condition, in step S1 of FIG. 2, the control in the normal operation mode by the switching condition is satisfied is switched to the control in the cooperative mode. In this instance, the release condition in steps S2 to S4 of FIG. 2 may be a condition for switching from the cooperative mode to the normal operation mode.

In the present disclosure, it is possible to suppress that the insertion and removal load of the charging connector is insufficient, and the automatic charging robot can be controlled to the cooperative mode.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An automatic charging system comprising:
a charger, installed in a charging facility, to which a charging cable having a charging connector is connected;
an automatic charging robot, including a robot arm having a robot hand at a tip portion thereof, for inserting the charging connector, which is gripped by the robot hand, into a charging port of a vehicle for perform charging;
a detector, provided in an infrastructure facility in a vicinity of the charging facility, for detecting a distance between the automatic charging robot and a person; and
a controller for controlling an operation of the automatic charging robot when performing automatic charging to the vehicle,
wherein the controller is configured to
execute a cooperative mode, in which the robot arm is operated in a manner that an output of the robot arm is limited to a predetermined value when controlling an operation of the robot arm to charge the vehicle and a predetermined execution condition is satisfied, and
operate the robot arm while turning off the cooperative mode when it is confirmed that there is no person or animal detected near the automatic charging robot in response to a signal input from the detector during execution of the cooperative mode.

2. The automatic charging system according to claim 1, wherein the detector is a laser scanner that detects a presence of the person or animal around the automatic charging robot.

3. The automatic charging system according to claim 1, wherein the detector is an infrastructure camera provided in a parking lot in which the charger and the automatic charging robot are installed.

4. The automatic charging system according to claim 1, wherein the controller varies at least one of a portable load and an operation speed of the robot arm according to the distance between the automatic charging robot and the person.
